(19) United States
(12) Patent Application Publication
(10) Pub. No.: US 2005/0080188 A1
(43) Pub. Date: Apr. 14, 2005

(54) Impact-resistant moulding materials and moulded bodies

(75) Inventors: Klaus Schultes, Wiesbaden (DE); Reiner Mueller, Biebesheim (DE); Werner Hoess, Griesheim (DE); Klaus Albrecht, Mainz (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: ROEHM GBMH & CO KG, Darmstadt (DE)

(21) Appl. No.: 10/502,057

(22) PCT Filed: Jan. 14, 2003
(86) PCT No.: PCT/EP03/00266

(30) Foreign Application Priority Data
Feb. 6, 2002 (DE) 102 04 890.8

(51) Int. Cl. C08L 83/10

(52) U.S. Cl. 525/101

(57) ABSTRACT

The invention relates to impact-resistant moulding materials comprising poly(meth)acrylate and at least one silicon rubber graft polymer comprising between 0.05 and 95 wt. %, in relation to the total weight of the copolymer, of a core a) consisting of an organosilicon polymer of general formula (R2SiO2/2)x (RSiO3/2)Y (SiO4/2)x wherein x=between 0 and 99.5 mole %, y=between 0.5 and 100 mole %, z=between 0 and 50 mole %, and R represents alkyl or alkenyl radicals comprising between 1 and 6 C atoms and being the same or different, aryl radicals or substituted hydrocarbon radicals; between 0 and 94.5 wt. %, in relation to the total weight of the copolymer, of a polydialkylsiloxane layer b); between 5 and 95 wt. %, in relation to the total weight of the copolymer, of an envelope c) consisting of organic polymers. The invention is characterised in that the core a) comprises vinyl groups, and the envelope c) can be obtained by radical polymerisation of a mixture containing acrylic acid esters and methacrylates.

The present invention relates to impact-resistant molding materials in which poly(meth)acrylate and at least one silicone rubber graft copolymer are present, and to impact-resistant moldings obtainable therefrom.

Various applications require moldings which have to have outstanding impact resistance, even at low temperatures. Among these, by way of example, are components for refrigerators, pipes, and automobiles which can be exposed to low temperatures.

To achieve this property, plastics are provided with what are known as impact modifiers. These additives are well known.

For example, silicone rubber graft copolymers which have a core-shell structure (C/S) are in particular used to improve impact resistance. Some of these modifiers even have a structure which encompasses two shells (C/S1/S2).

EP 430 134 discloses the preparation of modifiers for improving the impact resistance of molding materials. Here, a core, composed of a silicone rubber and of an acrylate rubber, is grafted with vinyl monomers. The material is then used for the impact-modification of molding materials—however, the only molding materials mentioned here are polycarbonate (PC) and/or polyester molding materials.

The document U.S. Pat. No. 4,690,986 describes an impact-resistant molding material which is prepared from a graft copolymer (via emulsion polymerization). The graft copolymer is a C/S product. The core is composed, inter alia, of a crosslinking agent (siloxane having a methacrylate group bonded via two or more CH₂ groups) and of tetrafunctional silane in the form of crosslinking agent. Both the molding material and a preparation process are described.

JP 612,135,462 describes a molding material which is prepared from a graft copolymer (via emulsion polymerization). The graft copolymer is composed of siloxane grafted with vinyl monomers.

EP 308 198 discloses a molding material composed of PMMI and of grafted polysiloxane. The graft polysiloxane is prepared via grafting of monomers and of at least one “graft-crosslinking agent”. In the subclaims it is clear that the graft-crosslinking agent is the crosslinking agent described in U.S. Pat. No. 4,690,986 (siloxane having a methacrylate group bonded via two or more CH₂ groups). The tetrafunctional silane is also mentioned as crosslinking agent in the subclaims.

EP 332 188 describes graft copolymers which are similar to those described in EP 430134. These graft copolymers are used for moadfying molding materials. In the example, particles are grafted with styrene and these are used for modifying a polyether/polysulfone blend.

DE 43 42 048 discloses graft copolymers with a C/S1/S2 structure. A silicone rubber functions as core, S1 is predominantly prepared from acrylates (min. 70%), and for preparing the shell S2 use may be made, for example, of monomer mixtures in which from 50 to 100% of methyl methacrylate are present. The subclaims also describe impact-resistant molding materials based on the graft copolymers described, and here again the polymer for the matrix is very broadly interpreted.

DE 3839287 describes a molding material which is composed of from 20 to 80% of conventional polymers and from 80 to 20% of graft copolymers. The graft copolymer has C/S1/S2 structure, the core being composed of silicone rubber and S1 of acrylate rubber. S2 is prepared via redox polymerization (emulsion) of a very wide variety of monomers. The only example listed is an impact-modified SAN molding material.

The publication WO 99141315 discloses dispersions which include a mixture of particles composed of vinyl copolymers and composed of PMMA-encapsulated silicone rubber. This dispersion can be used as impact modifier, inter alia.

EP 492 376 describes graft copolymers which have a C/S or C/S1/S2 structure. The core and the optional intermediate shell are composed of silicone rubber and are more precisely defined—the outer shell is prepared by emulsion polymerization of a very wide variety of monomers.

It is problematic that different plastics react in different ways to the addition of impact modifiers, the impact resistance of plastics here being very highly dependent on the monomers used for the preparation process. By way of example, polycarbonate intrinsically has very good impact resistance. However, components composed of this material are relatively susceptible to scratching, and there are therefore many sectors where this polymer cannot be used. Furthermore, the weathering resistance of polycarbonate is inadequate for many requirements.

Poly(meth)acrylates have outstanding properties when compared with the abovementioned plastic. However, the impact resistance of these polymers is intrinsically very low, and the addition of known impact modifiers does not lead to adequate improvement of impact resistance at low temperatures.

It is particularly problematic that the addition of large amounts of additives can impair the mechanical properties of the plastics, and there is therefore great restriction on the total amounts which can be added.

In addition, many articles are used not only at very high temperatures but also at very low temperatures. Among the examples here are automobiles which in cold regions are exposed to temperatures as low as −40° C. in winter. However, these vehicles are used at temperatures above 50° C. in desert regions.

A problem with known impact modifiers, however, is that the improvement in impact resistance values is temperature-dependent.

In the light of the prior art stated and discussed herein, an object of the present invention was therefore to provide molding material's with good mechanical properties and high impact resistance.

A further object of the invention was that the molding material should be capable of low-cost production.

Another object on which the invention was based was to provide molding materials whose impact strength is within an acceptable range over a large temperature range.

It was moreover therefore an object of the present invention to provide impact-resistant molding materials which can be processed by known molding processes.

Another object of the present invention consisted in providing impact-resistant moldings with outstanding mechanical properties which have high impact resistance beginning at a temperature of −40° C. and above that temperature.

The molding materials should moreover have high weathering resistance.

The molding materials described in claim 1 achieve these objects, and also achieve other objects which although they are not expressly mentioned are obvious or necessary consequences of the circumstances discussed herein. Useful embodiments of the inventive molding materials are protected in the subclaims dependent on claim 1.

The measures described in claim 16 achieve the object in relation to the impact-resistant moldings.

Molding materials which have exceptional mechanical properties together with very good impact resistance values are successfully provided if a poly(meth)acrylate-containing molding material comprises a silicone rubber graft copolymer whose core a) composed of an organosilicon polymer encompasses vinyl groups prior to the grafting process, and whose shell c) composed of organic polymers is obtainable via free-radical polymerization of a mixture in which acrylic esters and methacrylates are present, where the silicone rubber graft copolymer is composed of from 0.05 to 95% by weight, based on the total weight of the copolymer, of a core a) composed of an organosilicon polymer which has the general formula (R₂SiO_{2/2})ₓ.(RSiO_{3/2})_{y}.(SiO_{4/2})_{z} where x=from 0 to 99.5 mol %, y=from 0.5 to 100 mol %, z=from 0 to 50 mol %, where R means identical or different alkyl or alkenyl radicals having from 1 to 6 carbon atoms, aryl radicals, or substituted hydrocarbon radicals, from 0 to 94.5% by weight, based on the total weight of the copolymer, of a polydialkylsiloxane layer b), and from 5 to 95% by weight, based on the total weight of the copolymer, of a shell c).

Advantages achieved by the inventive measures are, inter alia, particularly the following:
The inventive molding materials perform very well at low temperatures. For example, very good impact resistance values are in particular achieved at temperatures below 0° C.
The molding materials of the present invention may be processed in a known manner.
Moldings obtained from the molding materials in accordance with the present teaching have an outstanding modulus of elasticity. For example, particular embodiments have a modulus of elasticity to ISO 527-2 of at least 1500, preferably at least 1600, particularly preferably at least 1700 MPa.
Moldings produced from the inventive molding materials moreover have very good weathering resistance.
Inventive moldings are very heat-resistant.

Preferred moldings have Vicat softening points (ISO 306 (B50)) above 85° C., preferably above 90° C., and particularly preferably above 95° C.

The molding materials of the present invention comprise poly(meth)acrylates. The term (meth)acrylates encompasses methacrylates and acrylates, and also mixtures of the two.

Poly(meth)acrylates are well known to persons skilled in the art. These polymers are generally obtained via free-radical polymerization of mixtures which comprise (meth)acrylates.

These monomers are well known. Among them are, inter alia,
(meth)acrylates derived from saturated alcohols, e.g. methyl (meth)acrylate, ethyl (meth)acrylate, propyl (meth)acrylate, n-butyl (meth)acrylate, tert-butyl (meth)acrylate, pentyl (meth)acrylate and 2-ethylhexyl (meth)acrylate; (meth)acrylates derived from unsaturated alcohols, e.g. oleyl (meth)acrylate, 2-propynyl (meth)acrylate, allyl (meth)acrylate, vinyl (meth)acrylate;
aryl (meth)acrylates, such as benzyl (meth)acrylate or phenyl (meth)acrylate, where each of the aryl radicals may be unsubstituted or have up to four substituents; cycloalkyl (meth)acrylates, such as
3-vinylcyclohexyl (meth)acrylate, bornyl (meth)acrylate;
hydroxyalkyl (meth)acrylates, such as
3-hydroxypropyl (meth)acrylate,
3,4-dihydroxybutyl (meth)acrylate,
2-hydroxyethyl (meth)acrylate, 2-hydroxypropyl (meth)acrylate;
glycol di(meth)acrylates, such as 1,4-butanediol di(meth)acrylate,
(meth)acrylates of ether alcohols, such as
tetrahydrofurfuryl (meth)acrylate,
vinyloxyethoxyethyl (meth)acrylate;
amides and nitriles of (meth)acrylic acid, e.g.
N-(3-dimethylaminopropyl)(meth)acrylamide,
N-(diethylphosphono)(meth)acrylamide,
1-methacryloylamido-2-methyl-2-propanol;
sulfur-containing methacrylates, such as
ethylsulfinylethyl (meth)acrylate,
4-thiocyanatobutyl (meth)acrylate,
ethylsulfonylethyl (meth)acrylate,
thiocyanatomethyl (meth)acrylate,
methylsulfinylmethyl (meth)acrylate,
bis((meth)acryloyloxyethyl) sulfide;
multifunctional (meth)acrylates, such as
trimethylolpropane tri(meth)acrylate.

Besides the (meth)acrylates described above, the compositions to be polymerized may also comprise other unsaturated monomers copolymerizable with the abovementioned (meth)acrylates. The amount generally used of these compounds is from 0 to 50% by weight, preferably from 0 to 40% by weight, and particularly preferably from 0 to 20% by weight, based on the weight of the monomers, and the comonomers here may be used individually or in the form of a mixture.

Among these are, inter alia, 1-alkenes, such as 1-hexene, 1-heptene; branched alkenes, such as vinyl-cyclohexane, 3,3-dimethyl-1-propene, 3-methyl-1-diiso-butylene, 4-methyl-1-pentene;
acrylonitrile; vinyl esters, such as vinyl acetate; styrene, substituted styrenes having an alkyl substituent in the side chain, e.g. α-methylstyrene and α-ethylstyrene, substituted styrenes having an alkyl substituent on the ring, such as vinyltoluene and p-methylstyrene, halogenated styrenes, such as monochlorostyrenes, dichlorostyrenes, tribromostyrenes, and tetrabromostyrenes;
heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinyl-pyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinyl-pyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles, and hydrogenated vinylthiazoles, vinyloxazoles, and hydrogenated vinyloxazoles;
vinyl and isoprenyl ethers;
maleic acid derivatives, such as maleic anhydride, methyl maleic anhydride, maleinimide, methylmaleinimide; and
dienes, such as divinylbenzene.

The polymerization is generally initiated with known free-radical initiators. Examples of preferred initiators are the azo initiators well known to persons skilled in the art, e.g. AIBN and 1,1-azobiscyclohexanecarbonitrile, and also peroxy compounds, such as methyl ethyl ketone peroxide, acetylacetone peroxide, dilauryl peroxide, tert-butyl per-2-ethylhexanoate, ketone peroxide, methyl isobutyl ketone peroxide, cyclohexanone peroxide, dibenzoyl peroxide, tert-butyl peroxybenzoate, tert-butylperoxy isopropyl carbonate, 2,5-bis(2-ethylhexanoylperoxy)-2,5-dimethylhexane, tert-butylperoxy 2-ethylhexanoate, tert-butylperoxy 3,5,5-trimethylhexanoate, dicumyl peroxide, 1,1-bis-(tert-butylperoxy)cyclohexane, 1,1-bis(tert-butyl-peroxy)-3,3,5-trimethylcyclohexane, cumyl hydroperoxide, tert-butyl hydroperoxide, bis(4-tert-butylcyclohexyl) peroxydicarbonate, mixtures of two or more of the abovementioned compounds with one another, and also mixtures of the abovementioned compounds with compounds not mentioned which can likewise form free radicals.

The amount often used of these compounds is from 0.1 to 10% by weight, preferably from 0.5 to 3% by weight, based on the total weight of the monomers.

Preferred poly(meth)acrylates are obtainable via polymerization of mixtures which comprise at least 20% by weight, in particular at least 60% by weight, and particularly preferably at least 80% by weight, of methyl methacrylate, based in each case on the total weight of the monomers to be polymerized.

Use may be made here of various poly(meth)acrylates which differ, by way of example, in molecular weight or in monomer composition.

The molding materials may moreover comprise other polymers for modification of the properties. Among these are, inter alia, polyacrylonitriles, polystyrenes, polyethers, polyesters, polycarbonates, and polyvinyl chlorides. These polymers may be used individually or in the form of a mixture, and copolymers derivable from the abovementioned polymers may also be added here to the molding materials. Among these are in particular styrene-acrylonitrile polymers (SANs), the amount of which added to the molding materials is preferably up to 45% by weight.

Particularly preferred styrene-acrylonitrile polymers may be obtained via polymerization of mixtures composed of
from 70 to 92% by weight of styrene
from 8 to 30% by weight of acrylonitrile, and
from 0 to 22% by weight of other comonomers, based in each case on the total weight of the monomers to be polymerized.

In particular embodiments, the proportion of the poly(meth)acrylates is at least 20% by weight, preferably at least 60% by weight, and particularly preferably at least 80% by weight.

Particularly preferred molding materials of this type are commercially obtainable from Rohm GmbH & Co. KG with the trademark PLEXIGLAS®.

The weight-average molar mass \overline{M}_{w} of the homo- and/or copolymers to be used according to the invention as matrix polymers may vary widely, and the molar mass here is usually matched to the application and the mode of processing of the molding material. However, it is usually in the range from 20 000 to 1 000 000 g/mol, preferably from 50 000 to 500 000 g/mol, and particularly preferably from 80 000 to 300 000 g/mol, with no intended resultant restriction.

To improve the impact resistance values, silicone rubber graft copolymers are admixed according to the invention with the molding materials and are composed of from 0.05 to 95% by weight, based on the total weight of the copolymer, of a core a) composed of an organosilicon polymer having the general formula (R₂SiO_{2/2})ₓ.(RSiO_{3/2})_{y}.(SiO_{4/2})_{z} where x=from 0 to 99.5 mol %, y=from 0.5 to 100 mol %, z=from 0 to 50 mol %, where R means identical or different alkyl or alkenyl radicals having from 1 to 6 carbon atoms, aryl radicals, or substituted hydrocarbon radicals, from 0 to 94.5% by weight, based on the total weight of the copolymer, of a polydialkylsiloxane layer b), and from 5 to 95% by weight, based on the total weight of the copolymer, of a shell c) composed of organic polymers, and where the core a) encompasses vinyl groups prior to the grafting process, and the shell c) is obtainable via free-radical polymerization of a mixture in which acrylic esters and methacrylates are present.

The core a) of the silicone rubber graft copolymer encompasses an organosilicon polymer which has the general formula (R₂SiO_{2/2})ₓ.(RSiO_{3/2})_{y}.(SiO_{4/2})_{z} where x=from 0 to 99.5 mol %, y=from 0.5 to 100 mol %, z=from 0 to 50 mol %, where R means identical or different alkyl or alkenyl radicals having from 1 to 6 carbon atoms, aryl radicals, or substituted hydrocarbon radicals.

The radicals R are preferably alkyl radicals, such as the methyl, ethyl, n-propyl, isopropyl, n-butyl, sec-butyl, amyl, hexyl radical; alkenyl radicals, such as the ethenyl, propenyl, butenyl, pentenyl, hexenyl, and allyl radical; aryl radicals, such as the phenyl radical; or substituted hydrocarbon radicals.

Examples of these are halogenated hydrocarbon radicals, such as the chloromethyl, 3-chloropropyl, 3-bromo-propyl, 3,3,3-trifluoropropyl, and 5,5,5,4,4,3,3-heptafluoropentyl radical, and also the chlorophenyl radical; mercaptoalkyl radicals, such as 2-mercaptoethyl and 3-mercaptopropyl radicals; cyanoalkyl radicals, such as the 2-cyanoethyl and 3-cyanopropyl radical; aminoalkyl radicals, such as the 3-aminopropyl radical; acryloxyalkyl radicals, such as the 3-acryloxypropyl and 3-methacryloxypropyl radical; hydroxyalkyl radicals, such as the hydroxypropyl radical.

Particular preference is given to the radicals methyl, ethyl, propyl, phenyl, ethenyl, 3-methacryloxypropyl and 3-mercaptopropyl, and it is preferable here that less than 30 mol % of the radicals in the siloxane polymer are ethenyl, 3-methacryloxypropyl, or 3-mercaptopropyl groups.

According to invention, the core a) has vinyl groups prior to grafting. This group may have direct bonding to an Si atom, or have bonding via an alkylene radical, such as methylene, ethylene, propylene, and butylene. The inventive vinyl groups of the core a) may therefore be obtained, inter alia, via use of organosilicon compounds which have ethenyl, propenyl, butenyl, pentenyl, hexenyl, and/or allyl radicals.

The content of vinyl groups in the core a) prior to grafting is in particular in the range from 0.5 to 10 mol %, preferably from 1 to 6 mol %, and particularly preferably from 2 to 3 mol %. The mol % data represent the molar proportion of the vinyl-containing starting compounds, which for the purposes of calculation have one vinyl group, in all of the monomeric organosilicon compounds used to prepare the core a).

In one preferred embodiment, the vinyl groups have inhomogeneous distribution in the silicone core, the proportion in the outer region of the silicone core being higher than in the region of the center of gravity of the core. The location of 85%, particularly 90%, of all of the vinyl groups is preferably in the outer shell of the silicone core. This outer shell of the silicone core is formed by 40% of the radius, and the volume of the outer shell is therefore specified via the formula V=4π/3*r³−4π/3*(0.6*r)³.

The organosilicon shell polymer b) is preferably composed of dialkylsiloxane units (R₂SiO_{2/2}), where R is methyl or ethyl.

According to the invention, the shell c) comprises polymers which are obtainable from mixtures in which methacrylate and acrylic esters are present.

With respect to the definition of the methacrylates and acrylic esters, reference may be made to the above disclosure. Besides the methacrylates and acrylic esters, the mixtures may comprise other monomers which are copolymerizable with these (meth)acrylates. These monomers have also been mentioned above.

The preferred methacrylate is methyl methacrylate. Preference is also given to acrylic esters which encompass from 1 to 8 carbon atoms. Among these are methyl acrylate, ethyl acrylate, propyl acrylate, n-butyl acrylate, tert-butyl acrylate, pentyl acrylate, hexyl acrylate, and 2-ethylhexyl (meth)acrylate. Particular preference is given to mixtures which comprise methyl methacrylate and ethyl acrylate.

The ratio of acrylic ester to methacrylate may vary widely. The ratio by weight of acrylic ester to methacrylate in the mixture for preparing the shell c) is preferably in the range from 50:50 to 1:99, particularly preferably in the range from 10:90 to 2:98, and very particularly preferably in the range from 5:95 to 3:97, with no intended resultant restriction.

The ratio of the weight of core a) and shell b) to the weight of the shell c) of the silicone rubber graft copolymers is preferably in the range from 90:10 to 20:80, in particular from 80:20 to 30:70, and particularly preferably from 70:30 to 55:65, with no intended resultant restriction.

According to one preferred embodiment, the silicone rubber graft copolymers have a particle size in the range from 5 to 500 nm, in particular from 10 to 300 nm, and particularly preferably from 30 to 200 nm. The particle size is based on the largest dimension of the particles. In the case of spherical particles, the particle size is given by the particle diameter.

In another aspect of the present invention, the silicone rubber graft copolymers have monomodal distribution with a polydispersity index of not more than 0.4, in particular not more than 0.2, with no intended resultant restriction.

The particle size may be measured using particle size determination equipment whose function uses the principle of photon correlation spectroscopy, obtainable from Coulter with the trade name Coulter N4, in water at room temperature (23° C.). This determination equipment is tested using appropriate reference lattices of varying particle size, the particle size of which is determined via ultracentrifuge measurements. The particle size is therefore based on an average determined by the abovementioned method.

The polysiloxane graft base may be prepared by the emulsion polymerization process. Here, from 0.05 to 95% by weight, based on the total weight of the graft copolymer to be prepared, of one or more monomeric silanes of RₐSi(OR′)₄₋ₐ type, where a=0, 1, or 2, are metered into an emulsifier/water mixture which is kept in motion. The radical R′ represents alkyl radicals having from 1 to 6 carbon atoms, aryl radicals, or substituted hydrocarbon radicals, preference being given to methyl, ethyl, and propyl radicals. The radical R is as defined above.

Suitable emulsifiers are carboxylic acids having from 9 to 20 carbon atoms, aliphatically substituted benzenesulfonic acids having at least 6 carbon atoms in the aliphatic substituents, aliphatically substituted naphthalenesulfonic acids having at least 4 carbon atoms in the aliphatic substituents, aliphatic sulfonic acids having at least 6 carbon atoms in the aliphatic radicals, silylalkylsulfonic acids having at least 6 carbon atoms in the alkyl substituents, aliphatically substituted diphenyl ether sulfonic having at least 6 carbon atoms in the aliphatic radicals, alkyl hydrogensulfates having at least 6 carbon atoms in the alkyl radicals, quaternary ammonium halides or quaternary ammonium hydroxides. All C the acids mentioned may be used in unmodified form or, where appropriate, in a mixture with their salts. If use is made of anionic emulsifiers, it is advantageous to use those whose aliphatic substituents contain at least 8 carbon atoms. Preferred anionic emulsifiers are aliphatically substituted benzenesulfonic acids. If use is made of cationic emulsifiers, it is advantageous to use halides. The amount of emulsifier to be used is from 0.5 to 20.0% by weight, preferably from 1.0 to 3.0% by weight, based in each case on the amount of organosilicon compounds used. The silane or the silane mixture is added as a feed. The emulsion polymerization is carried out at a temperature of from 30 to 90° C., preferably from 60 to 85° C. In one preferred aspect of the present invention, the core a) is prepared at atmospheric pressure.

The pH of the polymerization mixture may vary widely. This value is preferably in the range from 1 to 4, particularly preferably from 2 to 3.

The polymerization to prepare the graft base may be carried out either continuously or else batchwise. Of these methods, batchwise preparation is preferred.

In the continuous method, the residence time in the reactor is generally from 30 to 60 minutes, with no intended resultant restriction.

In batchwise preparation of the graft base, it is advantageous for the stability of the emulsion to continue stirring for from 0.5 to 5.0 hours after the feed has ended. In one preferred embodiment, for further improvement of the stability of the polysiloxane emulsion, alcohol liberated during the hydrolysis can be removed by distillation, especially if the proportion of silane of the general formula RSi(OR′)₃ is high.

In the first step of the reaction, the constitution of the silane phase, the feed amount of which is from 0.05 to 95% by weight, based on the total weight of the graft copolymer, and which has one or more components, comprises from 0 to 99.5 mol % of a silane of the general formula R₂Si(OR′)₂ or of an oligomer of the formula (R₂SiO)ₙ, where n=from 3 to 8, from 0.5 to 100 mol % of a silane of the general formula RSi(OR′)₃, and from 0 to 50 mol % of a silane of the general formula Si(OR′)₄, where the mol % data are in each case based on the overall constitution of the graft base.

Examples of silanes of the general formula R₂Si(OR′)₂ are dimethyldiethoxysilane or dimethyldimethoxysilane. Examples of oligomers of the formula (R₂SiO) n, where n=from 3 to 8, are octamethylcyclotetrasiloxane or hexamethylcyclotrisiloxane.

Examples of silanes of the general formula RSi(OR′)₃ are methyltrimethoxysilane, phenyltriethoxysilane, vinyltrimethoxysilane, 3-chloropropyltrimethoxysilane, 3-mercaptopropyltrimethoxysilane and methacryloxypropyltrimethoxysilane.

Examples of silanes of the general formula Si(OR′)₄ are tetramethoxysilane or tetraethoxysilane. In one preferred embodiment, the graft base is also grafted with the organosilicon shell polymer b) prior to the grafting-on of the ethylenically unsaturated monomers.

This shell b) is likewise prepared by the emulsion polymerization process. For this, difunctional silanes of the general formula R₂Si(OR′)₂ or low-molecular-weight siloxanes of the general formula (R₂SiO_{2/2})ₙ, where n=from 3 to 8, are metered into the emulsion of the graft base, the emulsion being kept in motion. The radicals R and R′ here are as defined above. It is preferable not to add any further emulsifier, because the amount of emulsifier present in the emulsion is generally sufficient for stabilization.

The polymerization for grafting-on of the shell b) is carried out at a temperature of from 15 to 90° C. and preferably from 60 to 85° C. Operations here are usually carried out at atmospheric pressure. The pH of the polymerization mixture is from 1 to 4, preferably from 2 to 3. This step of the reaction, too, may take place either continuously or else batchwise. The residence times in the reactor for continuous preparation, and the continued stirring times in the reactor in the case of batchwise preparation, depend on the amount metered in of silanes or siloxanes and are preferably from 2 to 6 hours. In the most advantageous method, the steps of the reaction for preparing the graft base a) and the shell polymer b) are combined in a suitable reactor, and, where appropriate, the alcohol formed is finally removed by distillation.

The amount metered in of the difunctional silanes of the general formula R₂Si(OR′)₂ or low-molecular-weight siloxanes of the general formula (R₂SiO_{2/2}) n, where n=from 3 to 8, are such that the proportion of organosilicon shell polymer is from 0.5 to 94.5% by weight, preferably from 35 to 70% by weight, based on the total weight of the graft copolymer.

The solids content of the resultant siloxane elastomer soles, should be not more than 25% by weight, either with or without organosilicon shell polymer b), because otherwise a large rise in the viscosity makes it difficult to process the sols further in the form of graft base. Polysiloxanes obtainable via coagulation from sols of this type exhibit elastomeric properties. A simple method for characterizing the elasticity is determination of the swell factor by a method analogous to that given in U.S. Pat. No. 4,775,712. The swell factor should be >3.

In the final step of the preparation process, the abovementioned ethylenically unsaturated monomers are grafted onto the polysiloxane graft base, which has preferably been grafted with the organosilicon shell polymer b). For this, the amount metered in of the organic monomers is from 5 to 95% by weight, preferably from 30 to 70% by weight, based in each case on the total weight of the graft copolymer.

The grafting preferably takes place by the emulsion polymerization process in the presence of water-soluble or monomer-soluble free-radical initiators. Suitable free-radical initiators are water-soluble peroxo compounds, organic peroxides, hydroperoxides, or azo compounds. Examples of these compounds have been mentioned above. By way of example, K₂S₂O₈, KHSO₅, NaHSO₅, and butyl hydroperoxide are particularly preferably used to initiate the polymerization of the shell.

In particular embodiments, the free-radical initiators are mixed with a reductive component so that the polymerization can be carried out at a lower temperature.

Reductive components of this type are well-known. Among these are, inter alia, ferrous salts, such as FeSO₄, sodium bisulfite, sodium thiosulfate, and sodium hydroxymethylsulfinate (sodium formaldehyde-sulfoxylate).

The amount preferably used here of oxidation component and reduction component is from 0.01 to 2% by weight, based on the amount of monomer.

The reaction temperatures depend on the nature of the initiator used and are generally from 0 to 90° C., preferably from 20 to 65° C.

In this step of the reaction, too, it is preferable not to add any further emulsifier beyond the emulsifier added in the first stage.

An excessive emulsifier concentration can lead to solubilizate-free micelles, which can function as nuclei for purely organic latex particles. This step of the reaction, too, may be carried out either continuously or else batchwise. Known processes may be used to isolate the graft copolymers from the emulsion.

By way of example, the particles may be isolated via coagulation of the latices by freezing, salt addition, or addition of polar solvents, or by spray drying.

The procedure permits the particle size to be influenced not only via the emulsifier content but also via the reaction temperature, and the pH, and especially via the constitution of the graft copolymers. The average particle size here may be varied from 5 to 500 nm.

The introduction of an organosilicon shell b) brings about better bonding of the organopolymer shell phase c) to the organosilicon graft base.

The inventive molding materials may moreover comprise acrylate rubber modifier. Surprisingly, this can achieve excellent impact resistance performance at room temperature (about 23° C.) in the moldings produced from the inventive molding materials. It is particularly significant that the mechanical and thermal properties, such as the modulus of elasticity or the Vicat softening point, remain at a very high level. If an attempt is made to achieve similar notched impact resistance performance at room temperature solely via the use of acrylate rubber modifier or silicone rubber graft copolymer, there is a relatively marked fall-off in these values.

These acrylate rubber modifiers are known per se. They are copolymers which nave a core-shell structure, the core and the shell having a high proportion of the (meth)acrylates described above.

Preferred acrylate rubber modifiers here have a structure with two shells whose composition differs.

Particularly preferred acrylate rubber modifiers have, inter alia, the following structure:
Core: Polymer with at least 90% by weight methyl methacrylate content, based on the weight of the core.
Shell 1: Polymer with at least 80% by weight butyl acrylate content, based on the weight of the first shell.
Shell 2: Polymer with at least 90% by weight methyl methacrylate content, based on the weight of the second shell.

By way of example, a preferred acrylate rubber modifier may have the following structure:
Core: Copolymer composed of methyl methacrylate (95.7% by weight), ethyl acrylate (4% by weight), and allyl methacrylate (0.3% by weight)
S1: Copolymer composed of butyl acrylate (81.2% by weight), styrene (17.5% by weight), and allyl methacrylate (1.3% by weight)
S2: Copolymer composed of methyl methacrylate (96% by weight) and ethyl acrylate (4% by weight)

The core:shell(s) ratio of the acrylate rubber modifiers may vary widely. The core:shell ratio C/S by weight is preferably in the range from 20:80 to 80:20, with preference from 30:70 to 70:30 in the case of modifiers with one shell, or in the case of modifiers with two shells the core:shell 1:shell 2 ratio C/S1/S2 is preferably in the range from 10:80:10 to 40:20:40, particularly preferably from 20:60:20 to 30:40:30.

The particle size of the acrylate rubber modifier is usually in the range from 50 to 1000 nm, preferably from 100 to 500 nm, and particularly preferably from 150 to 450 nm, with no intended resultant restriction.

In one particular aspect of the present invention, the ratio by weight of silicone rubber graft copolymer to acrylate rubber modifier is in the range from 1:10 to 10:1, preferably from 4:6 to 6:4.

Particular molding materials are composed of
f1) from 20 to 95% by weight of (meth)acrylate polymers,
f2) from 0 to 45% by weight of styrene-acrylonitrile polymers,
f3) from 5 to 60% by weight of silicone rubber graft copolymers,
f4) from 0 to 60% by weight of acrylate-rubber-based impact modifier, based in each case on the weight of components f1-f4 and conventional additives.

The molding materials may comprise conventional additives of any type. Among these are, inter alia, antistatic agents, antioxidants, mold-release agents, flame retardants, lubricants, dyes, flow promoters, fillers, light stabilizers, and organic phosphorus compounds, such as phosphites or phosphonates, pigments, weathering stabilizers, and plasticizers.

Moldings which have excellent notched impact strength values can be obtained from the molding materials described above by known processes, such as injection molding or extrusion.

In one particular aspect of the present invention, moldings thus obtained can have a Vicat softening point to ISO 306 (B50) of at least 85° C., preferably at least 90° C., and particularly preferably at least 95° C., a notched impact strength NIS (Izod 180/1eA, 1.8 MPa) to ISO 180 of at least 3.0 kJ/m² at −20° C., and of at least 2.5 kJ/m² at −40° C., a modulus of elasticity to ISO 527-2 of at least 1500 MPa, preferably at least 1600 MPa, particularly preferably at least 1700 MPa.

The inventive molding material is particularly suitable for producing mirror housings, spoilers for vehicles, pipes, or protective coverings or components for refrigerators.

Inventive examples and comparative examples are used below to describe the invention in further detail, but there is no intention that the invention be restricted to these inventive examples.

Preparation of the Silicone Graft Copolymers

The following PDMS dispersions, without shell C, with a solids content of 20%, were prepared by a method based on the examples described on pages 5 to 7 of EP-0 492 376:
1. SLM 445205/GK 591
   Silicone rubber dispersion with 2 mol % content of methacrylic groups
2. SLM 445205/GK 592
   Silicone rubber dispersion with 2 mol % content of vinyl groups
3. SLM 445205/GK 645
   Silicone rubber dispersion with 3 mol % content of vinyl groups
4. SLM 445205/GK 643
   Silicone rubber dispersion with 2 mol % content of vinyl groups

Specification for preparing the silicone rubber copolymers from the abovementioned silicone rubber dispersions.

The PDMS dispersion given in table 1 formed an initial charge in the polymerization vessel at 55° C. (external vessel temperature control), with stirring. 3 g of concentrated acetic acid and 0.0035 g of ferrous sulfate were then added. A sodium hydroxymethyl-sulfinate solution which comprises 2.8 g of sodium hydroxymethylsulfinate and 50 g of water, is then added to the mixture by means of a dropping funnel over a period of about 20 min. At the same time, the addition of the respective monomer mixture, which also comprises 2 g of butyl hydroperoxide as initiator, is begun, the feed rate of the mixture of monomer and initiator being adjusted so that addition of this mixture takes place over a period of 3 hours. Once the feed has ended, the temperature is held at 55° C. for a further 30 minutes for continued reaction. The mixture is then cooled to 30° C., and the dispersion is filtered through a DIN 70 sieve fabric.

The following silicone graft copolymers were prepared in accordance with the method given above:

TABLE 1

| | Monomer mixture | PDMS core |
|---|---|---|
| Modifier A | Methyl methacrylate/ | SLM |
| | ethyl acrylate | 445205/GK 592 |
| | 761.3 g/31.7 g | 5950 g |
| Modifier B | Methyl methacrylate | SLM 445205/GK 591 |
| | 793 g | 5950 g |
| Modifier C | Methyl methacrylate | SLM 445205/GK 592 |
| | 793 g | 5950 g |
| Modifier D | Methyl methacrylate/ | SLM 445205/GK 643 |
| | ethyl acrylate | 5950 g |
| | 934.7 g/38.9 g | |
| Modifier E | Methyl methacrylate/ | SLM 45205/GK 645 |
| | ethyl acrylate | 5950 g |
| | 761.3 g/31.7 g | |
| Modifier F | Methyl methacrylate/ | SLM 45205/GK 643 |
| | ethyl acrylate | 5950 g |
| | 761.3 g/31.7 g | |
| Modifier G | Methyl methacrylate/ | SLM 45205/GK 643 |
| | ethyl acrylate | 5950 g |
| | 489.6 g/20.4 g | |

The particle size, determined using Coulter N4 equipment, of the C/S modifiers prepared as in table 1 were as described in table 2 which also gives the core/shell ratio.

TABLE 2

| | Particle radius [nm] | Core/shell ratio |
|---|---|---|
| Modifier A | 72 | 60/40 |
| Modifier B | 57 | 60/40 |
| Modifier C | 67 | 60/40 |
| Modifier D | 80 | 55/45 |
| Modifier E | 67 | 60/40 |
| Modifier F | 78 | 60/40 |
| Modifier G | 75 | 70/30 |

The dispersions are frozen at −20° C. and thawed after 2 days. The solid is then filtered off and dried at 60° C.

### INVENTIVE EXAMPLES 1 TO 6 AND COMPARATIVE EXAMPLES 1 AND 2

The resultant particles are mixed with a polymethyl methacrylate molding material available commercially from Rohm GmbH & Co. KG with the name Plexiglas® 7N, by means of an extruder. The molding materials were extruded to give test specimens on which mechanical and thermal properties were measured.

Die swell was measured to DIN 54811 (1984). Volume flow index (MVR) was measured to the test standard ISO 1133 (1997) at 230° C. with a load of 3.8 kg. The softening point is determined to DIN ISO 306 (August 1994); Mini-Vicat system (16 h/80° C.). Izod notched impact strength is measured to ISO 180 (1993). Modulus of elasticity is determined to ISO 527-2.

The amounts used of particles and of PMMA molding material are described in table 3.

TABLE 3

| | Modifier | Plexiglas ® 7N |
|---|---|---|
| Inventive example 1 | Modifier A | 77.5 g |
| | 22.5 g | |
| Comparative example 1 | Modifier B | 77.5 g |
| | 22.5 g | |
| Comparative example 2 | Modifier C | 77.5 g |
| | 22.5 g | |
| Inventive example 2 | Modifier D | 75.5 g |
| | 24.5 g | |
| Inventive example 3 | Modifier E | 77.5 g |
| | 22.5 g | |
| Inventive example 4 | Modifier F | 77.5 g |
| | 22.5 g | |
| Inventive example 5 | Modifier G | 80.7 g |
| | 19.3 g | |

The resultant mechanical and thermal properties are given in table 4.

TABLE 4

| | Inventive | Comparative | Comparative |
|---|---|---|---|
| | example 1 | example 1 | example 2 |
| Die swell [%] | 22.7 | 15.4 | 26.7 |
| Viscosity ηₛ | 2180 | 2447 | 2075 |
| (220° C./5 MPa) | | | |
| [Pa s] | | | |
| Mini-Vicat [° C.] | 100.5 | 99.1 | 98.7 |
| Izod NIS [kJ/m²] | | | |
| 23° C. | 5.6 | 3.22 | 5.25 |
| −20° C. | 5.0 | 2.88 | 4.18 |
| −40° C. | 4.4 | | |
| Modulus of | 2320 | 2129 | 2277 |
| elasticity [MPa] | | | |

| | Inventive | Inventive | Inventive |
|---|---|---|---|
| | example 2 | example 3 | example 4 |
| Die swell [%] | | | |
| MVR (230° C./3.8 kg) | 2.25 | 1.94 | 2.45 |
| [cm³/10 min] | | | |
| Mini-Vicat [° C.] | 101.0 | 100.6 | 100.9 |
| Izod NIS [kJ/m²] | | | |
| 23° C. | 6.4 | 5.7 | 6.1 |
| −20° C. | 5.4 | 4.5 | 5.3 |
| Modulus of | | | |
| elasticity [MPa] | | | |

| | Inventive |
|---|---|
| | example 5 |
| Die swell [%] | |
| MVR [cm³/10 min] | 1.7 |
| Mini-Vicat [° C.] | 100.8 |
| Izod NIS [kJ/m²] | |
| 23° C. | 6.3 |
| −20° C. | 4.9 |
| Modulus of | |
| elasticity [MPa] | |

From the data set out in table 4 it can be seen that modifiers obtainable by grafting a shell composed of a mixture in which acrylic esters and methacrylates are present onto a vinyl-containing core can give an excellent improvement in the impact resistance of PMMA molding materials.

### COMPARATIVE EXAMPLE 3

An acrylate-rubber-based modifier was prepared in accordance with the teaching of the publication DE 33 00 526. This modifier had the following composition:

| | |
|---|---|
| Core: | Copolymer composed of methyl methacrylate |
| | (95.7% by weight), ethyl acrylate (4% by |
| | weight), and allyl methacrylate (0.3% by |
| | weight) |
| S1: | Copolymer composed of butyl acrylate (81.2% by |
| | weight), styrene (17.5% by weight), and allyl |
| | methacrylate (1.3% by weight) |
| S2: | Copolymer composed of methyl methacrylate (96% |
| | by weight) and ethyl acrylate (4% by weight) |

19.7 g of this modifier were mixed, as in the process described above, with 80.3 g of the above-mentioned polymethyl methacrylate molding material.

The properties of this molding material were studied by the abovementioned methods, and the results are set out in table 5.

### INVENTIVE EXAMPLE 6

13.3 g of modifier A and 13.1 g of the acrylate rubber modifier used in comparative example 3 were mixed into 73.6 g of the abovementioned polymethyl methacrylate molding material.

The properties of this molding material were studied by the abovementioned methods, and the results are set out in table 5.

TABLE 5

| | Inventive | Comparative | Inventive |
|---|---|---|---|
| | example 1 | example 3 | example 6 |
| Die swell [%] | 22.7 | 25 | 19.8 |
| Viscosity ηₛ | 2180 | 1930 | 2380 |
| (220° C./5 MPa) | | | |
| [Pa s] | | | |
| Mini-Vicat [° C.] | 100.5 | 100 | 100 |
| Izod NIS [kJ/m²] | 5.6 | 4.3 | 6.4 |
| 23° C. | | | |
| Modulus of | 2320 | 2400 | 2200 |
| elasticity [MPa] | | | |

Table 5 shows that mixtures of acrylate rubber modifiers with silicone rubber modifiers have superior impact resistance values at room temperature. The selection of the mixtures was such that their softening point was similar. This improvement in impact resistance values at room temperature is attributable to unforeseeable synergy.

1. An impact-resistant molding material comprising
poly(meth)acrylate and
at least one silicone rubber graft copolymer comprising
from 0.05 to 95% by weight, based on the total weight of the copolymer, of a core a) comprising an organosilicon polymer which has the general formula (R₂SiO_{2/2})ₓ.(RSiO_{3/2})_{y}.(SiO_{4/2})_{z} where x=from 0 to 99.5 mol %, y=from 0.5 to 100 mol %, z=from 0 to 50 mol %, where R means identical or different alkyl or alkenyl radicals having from 1 to 6 carbon atoms, aryl radicals, or substituted hydrocarbon radicals,
from 0 to 94.5% by weight, based on the total weight of the copolymer, of a polydialkylsiloxane layer b), and
from 5 to 95% by weight, based on the total weight of the copolymer, of a shell c) comprising organic polymers, wherein the core a) encompasses vinyl groups prior to the grafting process, and the shell c) is obtainable via free-radical polymerization of a mixture in which acrylic esters and methacrylates are present.

2. The impact-resistant molding material as claimed in claim 1, wherein the ratio by weight of core a) and layer b) to the shell c) is in the range from 70:30 to 55:65.

3. The impact-resistant molding material as claimed in claim 1, wherein the ratio by weight of acrylic ester to methacrylate in the mixture for preparing the shell c) is in the range from 50:50 to 1:99.

4. The impact-resistant molding material as claimed in claim 1, wherein the molding material comprises at least 55% by weight of poly(meth)acrylates, based on the total weight.

5. The impact-resistant molding material as claimed in claim 1, wherein the molding material comprises at least one acrylate-rubber-based impact modifier.

6. The impact-resistant molding material as claimed in claim 5, wherein the particle diameter of the acrylate-rubber-based impact modifier is in the range from 50 to 1000 nm.

7. The impact-resistant molding material as claimed in claim 1, it comprises styrene-acrylonitrile polymers.

8. The impact-resistant molding material as claimed in claim 7, wherein the styrene-acrylonitrile polymers were obtained via polymerization of a mixture which comprises
from 70 to 92% by weight of styrene
from 8 to 30% by weight of acrylonitrile, and
from 0 to 22% by weight of other comonomers, based in each case on the total weight of the monomers to be polymerized.

9. The impact-resistant molding material as claimed in claim 1, wherein the molding material comprises
f1) from 20 to 95% by weight of (meth)acrylate polymers,
f2) from 0 to 45% by weight of styrene-acrylonitrile polymers,
f3) from 5 to 60% by weight of silicone rubber graft copolymers,
f4) from 0 to 60% by weight of acrylate-rubber-based impact modifier, based in each case on the weight of components f1-f4, and conventional additives.

10. The impact-resistant molding material as claimed in claim 1, wherein the silicone rubber graft copolymers have a particle diameter in the range from 10 to 300 nm.

11. The impact-resistant molding material as claimed in claim 1, wherein the shell c) was obtained via polymerization of a mixture in which methyl methacrylate and acrylic ester having from 1 to 8 carbon atoms are present.

12. The impact-resistant molding material as claimed in claim 1, wherein the acrylic ester is selected from the group consisting of ethyl acrylate, butyl acrylate, and mixtures thereof.

13. The impact-resistant molding material as claimed in claim 1, wherein the content of vinyl groups in the core a) is in the range from 2 to 3 mol %, based on the weight of the core.

14. An impact-resistant molding obtainable via extrusion or injection molding of a molding material as claimed in claim 1.

15. The impact-resistant molding as claimed in claim 14, wherein the molding has a Vicat softening point to ISO 306 (B50) of at least 85° C., a notched impact strength NIS (Izod 180/1eA, 1.8 MPa) to ISO 180 of at least 3.0 kJ/m² at −20° C. and of at least 2.5 kJ/m² at −40° C., a modulus of elasticity to ISO 527-2 of at least 1500 MPa.

16. The impact-resistant molding as claimed in claim 14, wherein the molding is a mirror housing or a spoiler for a vehicle, or is a pipe, or a protective cover, or a component of a refrigerator.
